(19) United States
(12) Patent Application Publication
(10) Pub. No.: US 2019/0067977 A1
(43) Pub. Date: Feb. 28, 2019

(54) MAGNETIC CHARGING DEVICE CAPABLE OF WIRELESS CHARGING

(71) Applicant: Dengjie Technology Co.,Ltd, Taichung (TW)

(72) Inventor: HUANG CHENG HUANG, TAICHUNG (TW)

(73) Assignee: Dengjie Technology Co., Ltd.

(21) Appl. No.: 15/692,497

(22) Filed: Aug. 31, 2017

(51) Int. Cl. H02J 7/02; H02J 7/00; H04B 5/00; H01F 3/10

(52) U.S. Cl. CPC H02J 7/025; H02J 7/0042; H02J 50/10; H01F 3/10; H04B 5/0037

(57) ABSTRACT

A charging device, which is configured to connect to a mobile device to charge the mobile device through a charging wire or through wireless charging, includes a connector and a wireless charging member. The connector has a plug, a magnetic ring, and a transmission module. The plug is configured to be inserted into a receptacle of a mobile device; the magnetic ring is coupled to the plug; and the transmission module has an end connected to the plug. The wireless charging member is connected to the transmission module to be electrically connected to the plug through the transmission module.

### BACKGROUND OF THE INVENTION

### 1. Technical Field

The present invention relates to an accessory of a mobile device, and more particularly to a magnetic charging device capable of wireless charging the mobile device.

### 2. Description of Related Art

Conventional mobile devices, such as cell phones and tablets, should be recharged after a predetermined time of use. Typically, there are two ways of charging, charging with a charging wire and charging without charging wire (wireless charging).

The charging wire has opposite ends connected to a power and a mobile device to charge the mobile device. There is a magnetic charging wire in the market, which has a first connector connected to a receptacle of the mobile device and a second connector connected to a cable. The first and the second connectors are provided with a magnetic member, two magnets or a magnet and an iron piece, respectively, so that the first and the second connectors are connected by magnetic force. In order to provide the function of quick charge, the first and the second connectors are provided with terminals with large areas. Such structure makes the first and the second connectors have a large size, and it is not suitable for a miniature design in the present days.

The wireless charging applies a first coil member connected to the mobile device and a second coil member in a wireless charging plate. The mobile device is able to be charged when the mobile device is put on the wireless charging plate.

In the present market, user has to replace a suitable protective case of the mobile device when either the large connector or the coil member for wireless charge is installed to the mobile device. It is inconvenient to the consumers, and furthermore, it costs the consumers much.

Therefore, to provide a connector, which has all the functions of magnetic connection, charging by the charging wire, wireless charging, small size, and applied for all models of mobile devices and protective cases, is an important issue in the present market.

### BRIEF SUMMARY OF THE INVENTION

In view of the above, the primary objective of the present invention is to provide a charging device, which has both charging functions of charging through a charging wire and wireless charging, and furthermore it has a small size.

In order to achieve the objective of the present invention, a charging device, which is configured to connect to a mobile device to charge the mobile device through a charging wire or through wireless charging, includes a connector and a wireless charging member. The connector has a plug, a magnetic ring, and a transmission module. The plug is configured to be inserted into a receptacle of a mobile device; the magnetic ring is coupled to the plug; and the transmission module has an end connected to the plug. The wireless charging member is connected to the transmission module to be electrically connected to the plug through the transmission module.

The connector is configured to connect to a charging wire through a magnetic force of the magnetic ring to charge the mobile device through the charging wire, and alternately the wireless charging member is configured to be put in an inductive range of a wireless charging plate to charge the mobile through wireless charging.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention, showing the connector connecting to the mobile device;

FIG. 2 is an exploded view of the preferred embodiment of the present invention;

FIG. 3 is a perspective view of the preferred embodiment of the present invention; and

FIG. 4 is a perspective view of the preferred embodiment of the present invention, showing the connectors of different models.

### DETAILED DESCRIPTION OF THE INVENTION

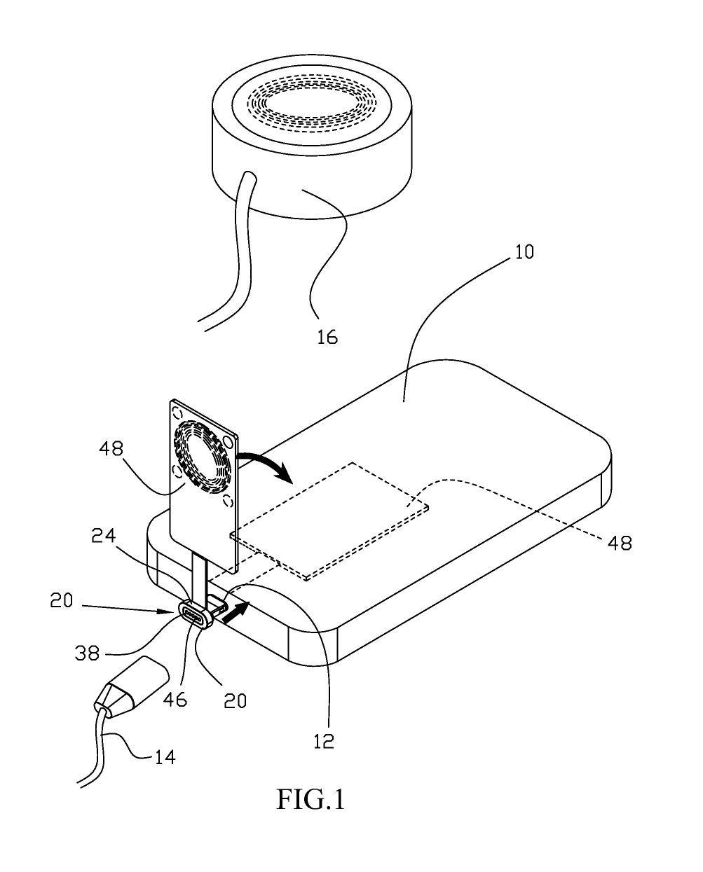

FIG. 1 shows a charging device of the preferred embodiment of the present invention includes a connector 20 inserted into a receptacle 12 of a mobile device 10. The connector 20 is able to connect to a charging wire 14 for charging the mobile device 10. The mobile device 10 also may be charged by putting the mobile device 10 on a charging plate 16 for wireless charging.

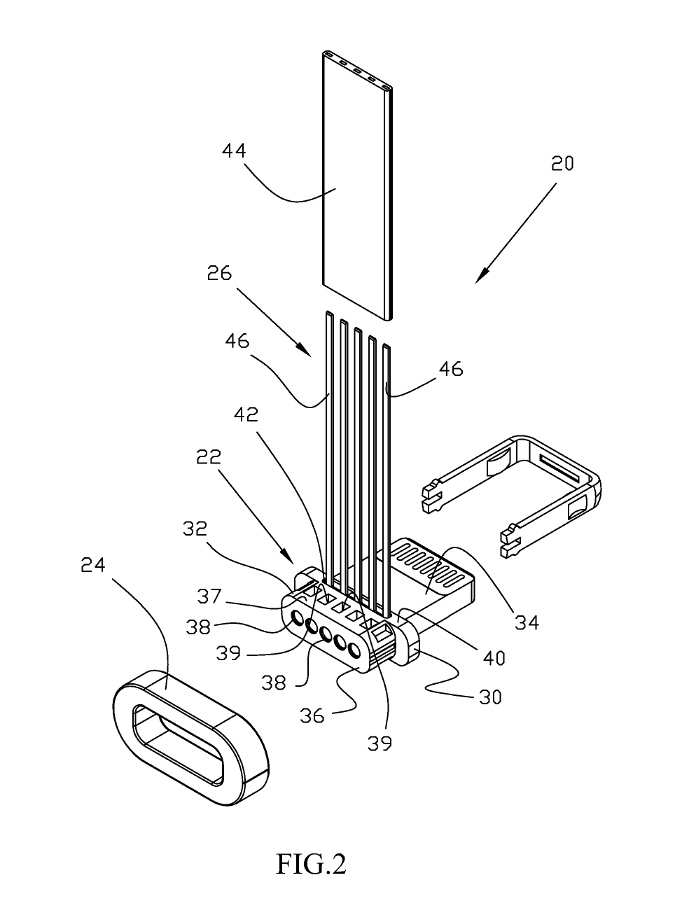

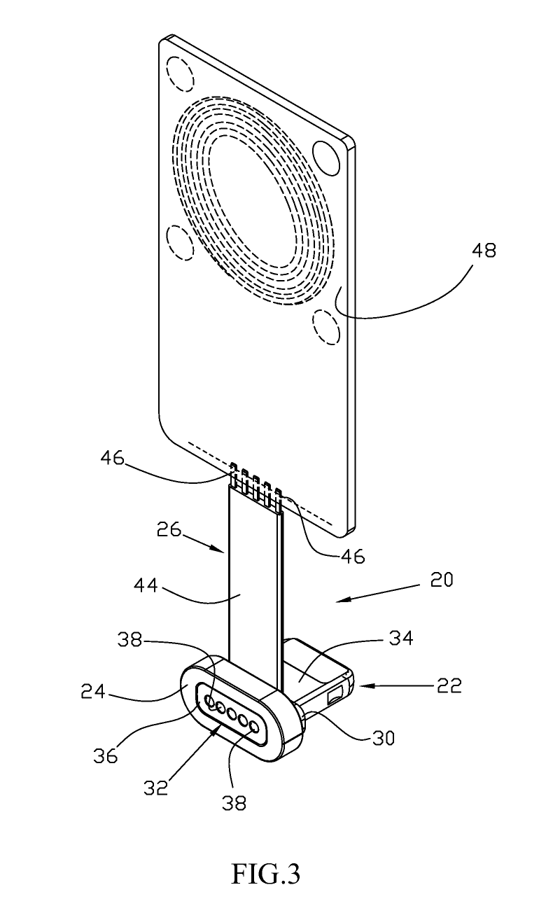

As shown in FIG. 2 and FIG. 3, the connector 20 includes a plug 22, a magnetic ring 24, and a transmission module 26. The plug 22 has a shoulder portion 30, a head portion 32 on a side of the shoulder portion 30, and an insertion portion 30 on an opposite side of the shoulder portion 30. The magnetic ring 24 is coupled to the head portion 32 and abuts against the shoulder portion 30. A circuit module (not shown) is received in the plug 22. Precisely, the circuit module is received in the insertion portion 34 and connected to the head portion 32. The circuit module is a conventional device, so we do not describe the detail here.

The head portion 32 has an end surface 36, on which a plurality of terminal bores 38 are provided, an upper surface 37, on which a plurality of welding bores 39 are provided, and a lateral surface 40, on which a bore 42 is provided (FIG. 2). The transmission module 26 has an insulating layer 44, in which a plurality of metallic pieces 46 are provided 46. The metallic pieces 46 are inserted into the bore 42, electrically connected to the circuit module, and received in the terminal bores 38, respectively. The welding bores 39 are provided for a manufacturer to weld the metallic pieces 46 onto the circuit module for an electrical connection. Opposite ends of the metallic pieces 46 are electrically connected to a wireless charging member 48 (FIG. 3). The metallic pieces 46 are flexible, so that the wireless charging member 48 is movable to a desired position.

As shown in FIG. 1, a user may connect the charging wire 14 to the connector 20 to charge the mobile device 10 through the charging wire 14. It is noted that the charging wire 14 is provided with a magnet or an iron member (nor shown) to be attracted by the magnetic ring 24 of the connector 20, which is helpful to the connection of the charging wire 14 and the connector 20. In addition, the charging wire 14 is provided with a plurality of elastic terminals (not shown) to contact with the metallic pieces 46 in the terminal bores 38.

In conclusion, the connector 20 of the present invention provides the mobile device 10 to be charged through the charging wire 14 or through the wireless charging member 48. Alternately, the user may put the mobile device 10 with the connector 20 on a wireless charging plate 16 with the wireless charging member 48 in an inductive range of the wireless charging plate 16. The mobile device 10 may be charged through wireless charging. Besides, the connector 20 provides the metallic pieces 46 for transmission electricity, which is more reliable than the conventional devices. The metallic pieces 46 further have the advantages of good rigidity, and keeping in low temperature when a large current flows therethrough. Therefore, the connector 20 of the present invention does not need large terminals to reduce the size of the connector 20, and applicable to any model of the mobile device and the protective case.

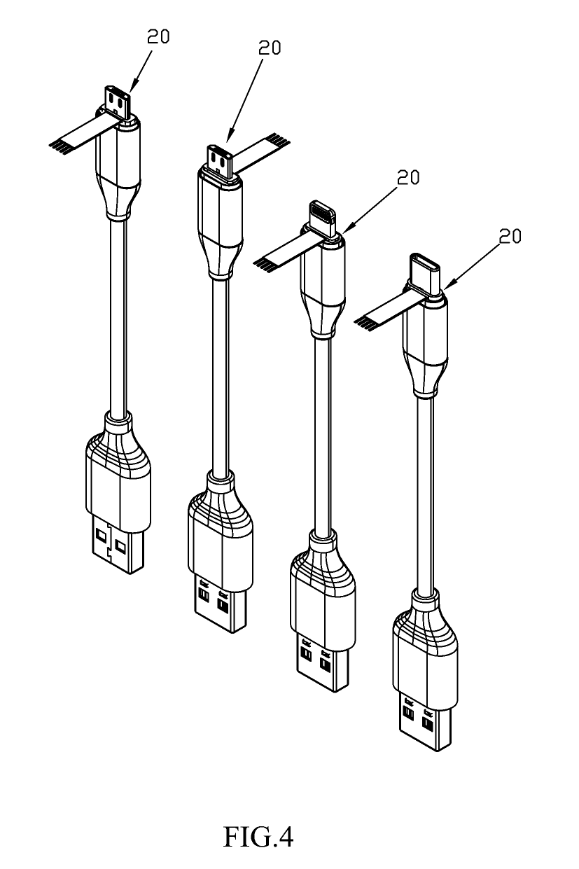

FIG. 4 shows the connectors 40 of the present invention in different types, the first and the second from the left are micro-USB connector, the third is Lightning connector, and the fourth is Type-C connector.

It must be pointed out that the embodiments described above are only some preferred embodiments of the present invention. All equivalent structures which employ the concepts disclosed in this specification and the appended claims should fall within the scope of the present invention.

What is claimed is:

1. A charging device, which is configured to connect to a mobile device to charge the mobile device through a charging wire or through wireless charging, comprising:
a connector having a plug, a magnetic ring, and a transmission module, wherein the plug is configured to be inserted into a receptacle of a mobile device; the magnetic ring is coupled to the plug; and the transmission module has an end connected to the plug; and
a wireless charging member connected to the transmission module to be electrically connected to the plug through the transmission module;
wherein the connector is configured to connect to a charging wire through a magnetic force of the magnetic ring to charge the mobile device through the charging wire, and alternately the wireless charging member is configured to be put in an inductive range of a wireless charging plate to charge the mobile through wireless charging.

2. The charging device of claim 1, wherein the plug has a shoulder portion, a head portion on a side of the shoulder portion, and an insertion portion on an opposite side of the shoulder portion; and the magnetic ring is coupled to the head portion and abuts against the shoulder portion.

3. The charging device of claim 1, wherein the transmission module has an insulating layer and a plurality of a plurality of metallic pieces passing through the insulating layer.

4. The charging device of claim 3, wherein the shoulder portion of the plug has a bore, through which the metallic pieces pass; and ends of the metallic pieces are electrically connected to the wireless charging member.

5. The charging device of claim 3, wherein the head portion of the plug has a plurality of terminal bores; and ends of the metallic pieces are received in the terminal bores respectively.

6. The charging device of claim 3, wherein the head portion of the plug has at least a welding bore, whereby by one is configured to weld the metallic pieces in the head portion through the welding bore.
